(19) United States
(12) Patent Application Publication
(10) Pub. No.: US 2002/0033686 A1
(43) Pub. Date: Mar. 21, 2002

(54) Electrical drive with motor identification, and a method for motor identification

(76) Inventor: Andreas Uhl, Erlangen (DE)

Correspondence Address: BAKER & BOTTS, 30 ROCKEFELLER PLAZA, NEW YORK, NY, 10112

(21) Appl. No.: 09/920,052

(22) Filed: Aug. 1, 2001

(30) Foreign Application Priority Data
Aug. 3, 2000 (DE) 100 379 68.0

(51) Int. Cl. G05B 11/01

(52) U.S. Cl. 318/560

(57) ABSTRACT

Clear association of a motor identification module (3) with the motor active part (1) of an electrical drive allows even those motors without any closed-loop drive control (2) or transmitter electronics to be identified uniquely and prevent confusion even during the production process and during assembly. The motor identification means (3) is evaluated via a bidirectional communication channel (10, 11) between the motor (1) and the closed-loop drive control (2), in which case even motors of an old type having a conventional temperature sensor (16) can be connected via the communication channel.

### BACKGROUND OF THE INVENTION

Motors are generally connected to closed-loop drive controllers by connecting the power cables of the motor (direct current, stepping, asynchronous and synchronous motors) via motor cables to the corresponding terminals of the input stage of the closed-loop drive controller. Depending on the application, appropriate additional cables are required between the motor and the closed-loop drive controller for motor temperature monitoring, or for initial commutation, for example by using Hall sensors, in order to connect the respective sensors directly to the closed-loop drive controller.

Normally, when the motor is being started up, the required information relating to the motor type and the motor characteristics (motor data) are entered on the closed-loop drive controller. This is associated with a corresponding time penalty and often represents a fault source due to incorrect inputs since, in some cases, the amount of data is quite extensive.

The use of old motors or motors other than normal ones is difficult since conventional closed-loop drive controllers are intended for evaluation of only one specific temperature sensor, which is used by the manufacturer in its motors. Nevertheless, there are a large number of switching and absolute-measurement temperature sensors for electric motors on the market.

If, in order to increase the power or to reduce the inertia, motors are connected in parallel to a closed-loop drive controller, this also results in problems in monitoring the temperatures of these motors since only one temperature sensor can generally be evaluated by the temperature sensor evaluation in the closed-loop drive controller, and it is impossible to check for the maximum from a number of temperature sensors.

Furthermore, it is important with regard to the machine parameters to be entered in the closed-loop drive controller on start-up, not only to know the type of motor but also to convert the machine parameters depending on the number of parallel-connected motors.

Known methods for motor identification use an additional nonvolatile memory in the electronics of the transmitter which is installed in or attached to the motor. However, this method is not possible when the transmitter is not a permanent component of the motor. For example, in torque motors, built-in motors, spindle motors and linear motors, the transmitter is generally not included in the items supplied with the motor, but rather obtained from another supplier depending on the design boundary conditions of the machine mechanism. There is also a risk of considerable damage or time losses during the start-up procedure occurring due to incorrect connection of the motor and transmitter cables or by confusing these cables with one another. In addition, the configuration in drive systems in which motors and transmitters are not connected directly to the closed-loop drive controller but are connected via network-like structures to different points on a machine, results in additional effort and possible faults.

The object of the present invention is therefore to provide a capability for motor identification by means of which all motors—even those without a transmitter or closed-loop drive control—can be identified uniquely irrespective of the transmitter electronics.

### SUMMARY OF THE INVENTION

The present invention provides an electrical drive having a motor, closed-loop drive control and an integrated, autonomous motor identification means, in particular a digital module in the form of a nonvolatile memory, wherein the motor identification means is arranged in the motor, and in particular in the primary part or active part of the motor.

In a first preferred embodiment of the electrical drive according to the present invention, a communication channel is provided, in particular a bidirectional communication channel, between the closed-loop drive control, e.g., a converter, and the motor identification means. The present invention can be implemented particularly advantageously and effectively if the bidirectional communication channel is integrated in the motor cable. It is preferred that the cables of the communication channels be connected in parallel when a number of motors are connected to one converter, in the form of a parallel circuit. The communication subscribers comprising the closed-loop drive control and the motor identification means in the respective motor, which are interconnected via the communication channels, behave, for example, like subscribers in a communication network such as a Local Area Network LAN. Since the bidirectional communication channel is in the form of a two-wire cable, the costs and cable complexity can be further minimized.

A particularly preferred method for supplying voltage to the motor identification means in the motor is for a charge store to be integrated in each motor identification means in order to supply power to it. The charge store can be charged by means of a high level on the two-wire cable.

In further preferred embodiment of the of electrical drive according to the present invention, a temperature sensor is integrated in the motor identification means and the latter is arranged within the primary part of the motor at the point to be measured, in particular in the end winding of the motor. This improves the degree of integration and thus reduces the cost.

It is particularly advantageous for the closed-loop drive control to be able to check the actual temperature value of the temperature sensor periodically via the bidirectional communication channel. Alternatively, the motor identification means has a preset temperature threshold and, if this temperature threshold is exceeded, an alarm signal can be passed to the closed-loop drive control via the bidirectional communication channel.

Furthermore, the present invention is intended for use not only in motors having a motor identification means and an integrated temperature sensor, but also in older motors of a conventional type having a conventional analog temperature sensor (for example NTC—negative temperature coefficient, PTC—positive temperature coefficient—or switches). In the case of such older motors, a communication channel driver on the closed-loop drive control side has an analog/digital converter via which an external, in particular conventional, temperature sensor can be evaluated. In addition to the motor type, the type of external temperature sensor which is connected can also be identified in a particularly advantageous manner via the bidirectional communication channel using the said analog/digital converter by the closed-loop drive control having an analog input which has a pull-up resistor which is connected via the bidirectional communication channel to the motor identification means, such that the pull-up resistor together with the motor identification means forms a voltage divider. This allows the analog/digital converter to be operated in conjunction with a digital communication channel driver on the closed-loop drive control side. When a conventional temperature sensor is connected to the terminals of the communication channel, a voltage drop that occurs is measured across the pull-up resistor and the series-connected conventional temperature sensor.

In the situation where no motor identification means with digital communication can be identified, a change is then advantageously made to operation with a conventional temperature sensor by means of a direct measurement via the voltage divider formed from the pull-up resistor and the conventional temperature sensor.

A further preferred embodiment of the present invention allows evaluation of commutation information via the devices according to the invention described above. The motor identification means has at least one digital input for checking commutation information, in particular for checking the rotor position by evaluation of Hall sensors or the like which are arranged in the motor.

In a further preferred embodiment of the present invention, the motor identification means has a memory area which can be written to for holding an operating configuration and/or fault information and this facilitates the repair and servicing of the electrical drive.

The motor identification means according to the invention can be used particularly advantageously for identification and/or as a data storage medium for test information or batch information associated with the motor during manufacture of a corresponding electrical drive.

A further preferred embodiment of the present invention provides for the identification of the components of a mechatronic system having an electrical drive according to the invention via the devices according to the invention described above. Specifically, in a master-slave mode, further sensors and/or actuators, in particular mechatronic components of the motor or a mechatronic subsystem, can be connected as slaves to the bidirectional communication channel which originates from the closed-loop drive control as the master.

Furthermore, the object described initially can also be achieved according to the present invention in the situation where a number of motors are connected in parallel to the closed-loop drive control. At the start of operation, in particular when the converter is being started up, the closed-loop drive control communicates with the individual motor identification means of the individual motors via the bidirectional communication bus. Each motor is identified on the basis of its motor identification means, and/or the connected configuration is identified, and/or a check is carried out of the permissibility to connect the motors in parallel.

Unique motor identification is made possible by the fact that a digital module, for example, with its own intelligence is located in each motor active part (but not in the transmitter or the closed-loop drive control) and has a number of functions (memory, A/D converter, temperature measurement, inputs/outputs) depending on the function assigned to it, in order to allow all the secondary states and characteristics of the motor active part to be detected and preprocessed. Unique automatic identification, without any possibility of confusion, of the individual spatially distributed components (for example converter, motor, transmitter) in a drive system is possible by virtue of the fact that the communication channels or cables for motor identification are interconnected and connected to the closed-loop drive control or to the converter in the same way as the motor cables (phase cables). With regard to communication and the power supply, the connection to the closed-loop drive controller can be made, for example, on the basis of the principle of the “MicroLan”, which is referred to as a “1-wire bus” ® (LAN in this case is short for Local Area Network).

### DRAWINGS

Further advantages and details of preferred embodiments of the invention are described in conjunction with the following figures, in which elements having the same functionality are denoted by the same reference symbols, and wherein:

FIG. 1 shows a block diagram illustrating the basic principle of motor identification according to the invention;

FIG. 2 shows an outline sketch of motor identification when a number of motors are connected to a closed-loop drive control in parallel;

FIG. 3 shows a block diagram of a motor active part with motor identification and additional detection of one or more temperature values at different points on the motor with the aid of sensors which are positioned locally and remotely from the electronics;

FIG. 4 shows a block diagram of a motor active part with additional evaluation of the rotor position as commutation information;

FIG. 5 shows the principle of temperature measurement for motors with a conventional temperature sensor; and

FIG. 6 shows an outline sketch of the networking of closed-loop drive control and a mechatronic unit, including an electric motor, based on the example of a main spindle of a machine tool.

### DETAILED DESCRIPTION OF THE INVENTION

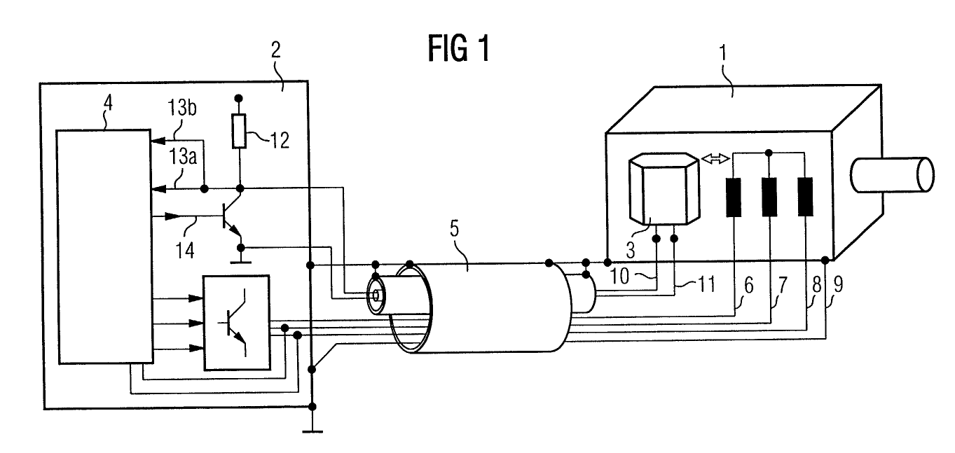

FIG. 1 shows an electrical drive with motor identification and additional detection of the motor temperature by means of a temperature sensor, integrated in the electronics, according to the invention. FIG. 1 takes into account most of the features described above. In addition to the motor windings, a motor primary part or active part 1 has a motor identification means 3, which is arranged within the motor 1. The motor identification means 3 preferably also has a temperature sensor, for which reason the element 3 should be arranged within the motor 1 in such a manner that the motor identification means 3 is arranged at the point to be measured.

A closed-loop drive control 2 is shown, for example, as a converter with a microprocessor 4 and corresponding active control devices for driving the motor cables 6 to 8, such as thyristors or transistors which are driven by the microprocessor. A common earth cable 9 is also provided.

The motor identification means 3 is connected via a bidirectional communication channel in the form of a two-wire cable 10, 11 to the microprocessor 4 of the drive controller 2. In addition to a digital output 14, the microprocessor 4 also has a digital input 13b and an analog input 13a. While the digital output 14 is connected via a driver transistor to the cable 11, the analog input 13a and digital input 13b are connected directly to the other cable 10. For the reasons explained in more detail in the following text, the analog input 13b and digital input 13a are also connected via a pull-up resistor 12 to the supply voltage.

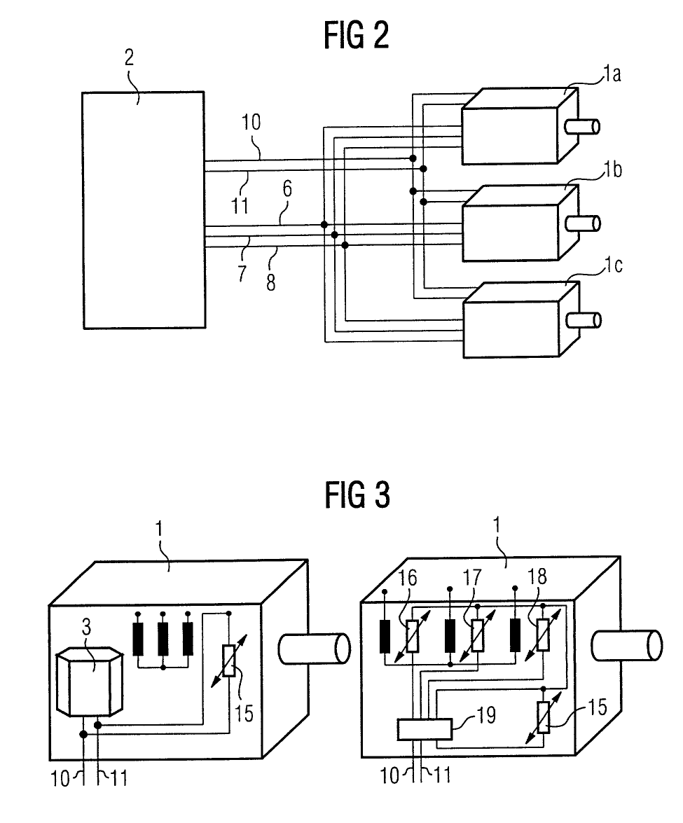

The motor cables 6 to 8 and the communication channel 10, 11 are preferably integrated in a common cable 5, in particular a shielded or separately shielded cable. As is shown in FIG. 2, one or more motors 1a, 1b, 1c each having motor identification means, can be connected in parallel via cable 5, which represents a communication bus which can communicate bidirectionally with the closed-loop drive controller 2.

If a number of motors 1a, 1b, 1c are connected in parallel to a closed-loop drive control 2 or to a converter, then the cables of the communication channel 10, 11 for motor identification are connected in parallel, in the same way as the motor phase cables 6, 7, 8, as well. There are then a number of subscribers on the motor identification bus and these subscribers can be recognized and identified automatically by the converter during the start-up operation. The interconnected configuration can be identified in a corresponding manner. Furthermore, a check can be carried out to determine whether the parallel connection is permissible (for example whether all the motors have the same winding data, etc.).

A high level on the communication channel 10, 11 is used together with a charge storage device integrated in the motor identification means 3 for supplying voltage to all the modules on the bus. Alternatively, a further third cable can also be used for supplying voltage separately to the motor identification means.

The integration of various functions in the respective motor identification module 3 allows the following options:

Addition of a memory module to the motor type identification and parameter check, for example when the converter is being started up, the type and parameters of the motor/motors 1, 1a, 1b, 1c can be checked by checking the motor identification modules 3 using the communication channel 10, 11;

Integration of a temperature sensor in the motor identification means 3 and installation of the motor identification module in the end winding of the motor 1, or at the location where the measurement is to be made, so that the actual motor temperature can be checked periodically by the closed-loop drive control 2, or the motor identification module 3 can produce an alarm signal automatically if a defined temperature threshold is exceeded; and

Addition of an analog/digital converter in the motor identification module 3 for detection of the sensor values of sensors which can be connected to the motor identification module, in particular by means of one or more external temperature sensors (for example in the end winding, bearing etc). The motor identification module 3 can in this case be positioned remotely from the motor winding. The temperature can be measured at a number of points (for example individual motor phases, coolant inlet temperature).

With regard to the above, and in contrast to the motor 1 illustrated in FIG. 1, the illustration in FIG. 3 shows two embodiments of a motor 1, each having an external temperature sensor 15 to 18. In the left-hand illustration, a temperature measurement is carried out with an external temperature sensor 15, for example, in the inlet for the cooling temperature, while in the embodiment in the right-hand illustration, further temperature sensors 16, 17, 18 are allocated to the three phases of the motor windings. In the latter case, the motor identification module 19 then has further connections and evaluation logic for the temperature sensors 15 to 18.

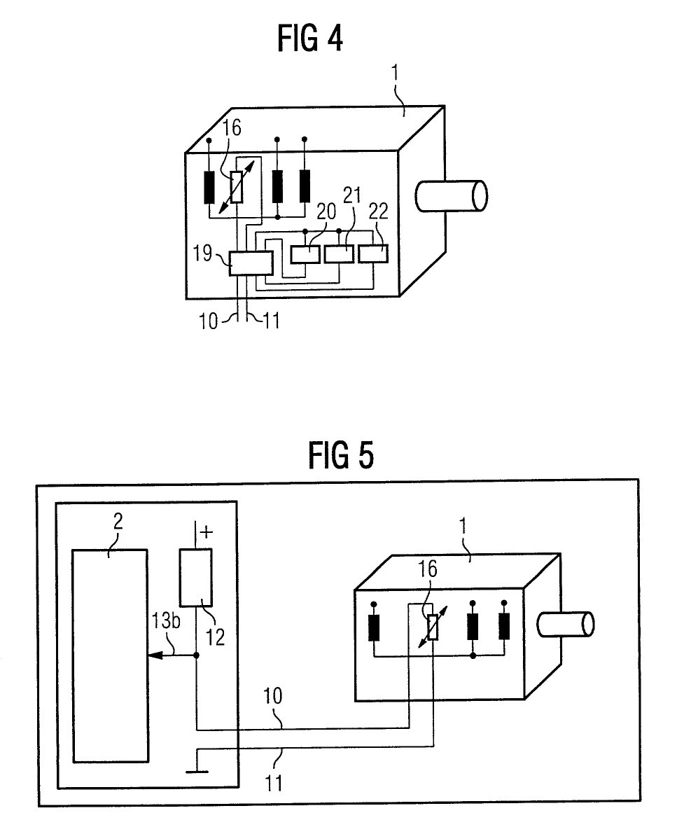

Digital inputs (possibly also suitable analog inputs) check the rotor position (commutation information). When the converter 2 is being started up, the corresponding commutation information can be checked, for example, via Hall sensors integrated in the winding of the motor (for example in the case of torque motors). One such possible advantageous embodiment is illustrated in the motor 1 shown in FIG. 4, with a motor identification module 19 for connection of a temperature sensor 16 and three Hall sensors 20 to 22.

The interface to the communication channel in the form of an identification bus is designed at the closed-loop drive controller 2 end in such a way that not only is bidirectional digital communication (for example in accordance with the Specification of the “1-wire bus”—J-1850 Data Communication Network, ISO K Line Serial Link Interface) possible via the digital inputs and outputs 13a, 13b, 14 to the microprocessor 4 or controller of the closed-loop drive controller 2, but it is also possible to use an analog input in conjunction with the pull-up resistor 12 to measure the resistance of an external temperature sensor or temperature switch 15 to 18 connected to the terminals. Thus, both types of motors, i.e., with a motor identification module 3 as well as “older” motors with conventional analog or switching temperature sensors, can be connected to the terminals of the identification bus 5 of the closed-loop drive controller.

Such a connection and resistance measurement on an external temperature sensor 16 is shown in FIG. 5, which is based on the block diagram shown in FIG. 1. The motor 1 and closed-loop drive control 2 are connected (in addition to the motor cables which are not shown) via the communication channel 10, 11, with the external temperature sensor 16 which is arranged on the motor 1 being connected to said communication channel 10, 11. The communication channel cable 10 is connected to the analog input 13a of the closed-loop drive control 2 and, via the pull-up resistor 12, to the supply voltage, so that the pull-up resistor 12 and the external temperature sensor 16 form a voltage divider.

The interface driver on the closed-loop drive control side has an additional analog input interface added to it so that it is possible to measure the voltage potential on the hot wire of the communication channel bus. If no motors with a motor identification chip 3 are used on the closed-loop drive control, then the pull-up resistor 12 of the driver together with the temperature sensor or temperature switch-off element 16 which is then connected to the communication channel 10, 11 form a voltage divider, which can be evaluated via the analog input. In addition to the evaluation of “old” motors, for example with a KTY 84 temperature sensor, it is also possible in this way to evaluate any desired temperature sensors from NTC via PTC to temperature switches. When the closed-loop drive control 2 is being started up, it attempts to communicate with the motor identification module 3 via the communication channel 10, 11.

If this process fails, then the type of conventional temperature sensor can be entered via a machine data item. A characteristic relating to this allows for the correct temperature evaluation and temperature monitoring.

The measures and circuit elements for motor identification according to the invention as described above result, inter alia, in the following advantages over the known prior art:

Clear association between the motor identification module 3 and the motor active part 1 (primary part or stator) makes it possible to identify all motors which are used individually without transmitter or converter electronics (for example spindles, built-in motors, linear motors, torque motors);

Clear association of the motor identification module 3 with the motor active part 1 makes it possible to identify the motor active part 1 uniquely and without confusion even during the production process and assembly; and

The precondition for fully automatic topology identification of a transmitter integrated in the motor 1 is satisfied. Specifically, if a number of motors 1a, 1b, 1c are being operated using one closed-loop drive controller 2, or if the machine has a number of motors or if the transmitter and power connections of the drives are located at physically different points for the purposes of decentralized drive concepts, then, in principle, there is a risk of confusion of the transmitter and motor connections 6 to 8 with one another and the association of the transmitters with the motors must be carried out by hand in any case during the start-up procedure (topology information).

If the motor now has its own identification system, which is independent of the transmitter, then this association process (configuration) can be carried out fully automatically.

All that is necessary to do this is for the identity of one of the components (transmitter or motor) to be made known to the respective other component during production (for example during transmitter installation or during a test run). The association process can then be carried out fully automatically by the closed-loop drive control 2 after the identification of the individual components on the respective connections/cables. The probability of errors, in particular with respect to the cabling, is in this way precluded, and the starting-up effort is reduced to a minimum.

If the motor identification module also contains a memory area which can be written to, then the last fault pattern of the drive system can be stored there (for example based on the principle of a fault stack) so that the fault history and the operational configuration can be used for fault finding and making decisions on reuse when the motor is returned and repaired.

The multifunctionality of the motor identification module 3 as described above allows all the relevant states of the motor 1 to be transferred from the motor identification module 3 to the closed-loop drive controller 2 via the one communication channel 10, 11 (for example a number of temperatures, Hall sensor information).

When using the “1-wire bus” principle, the wiring complexity for connecting the motor identification module or modules to a 2-wire cable 10, 11 is reduced. This can be integrated in the existing motor cable 6 to 8 so that no greater complexity is involved than with the previous motor connection with a conventional temperature sensor.

Further advantages of the motor identification module result from the capability to use the motor identification for unique identification (for example as a substitute for bar codes) even in the individual manufacturing and test steps (for example for transmitter adjustment), and in the capability to use it as a data storage medium for test and batch information associated with the motor 1. The motor identification module 3 can in this case easily be coupled to a standard USART interface via interface modules which are commercially available for the 1-wire bus.

Since a number of bus subscribers (slaves) can be connected to one communication channel 5 (see FIG. 2 and the associated descriptions), it is possible to regard the communication channel 5 originating from the closed-loop drive control 2 as a communication gateway to, for example, additional mechatronic components in a mechatronic system or subsystem (for example a main spindle system), in which bus subscribers are not only motor components but also additional sensors and actuators which are required for optimum operation of the mechatronic component. For example, in addition to the pole position, the coolant inlet temperature, various temperature measurement points in each phase of the winding, or the motor bearing temperature can also be taken into account by means of Hall sensors integrated in the motor winding.

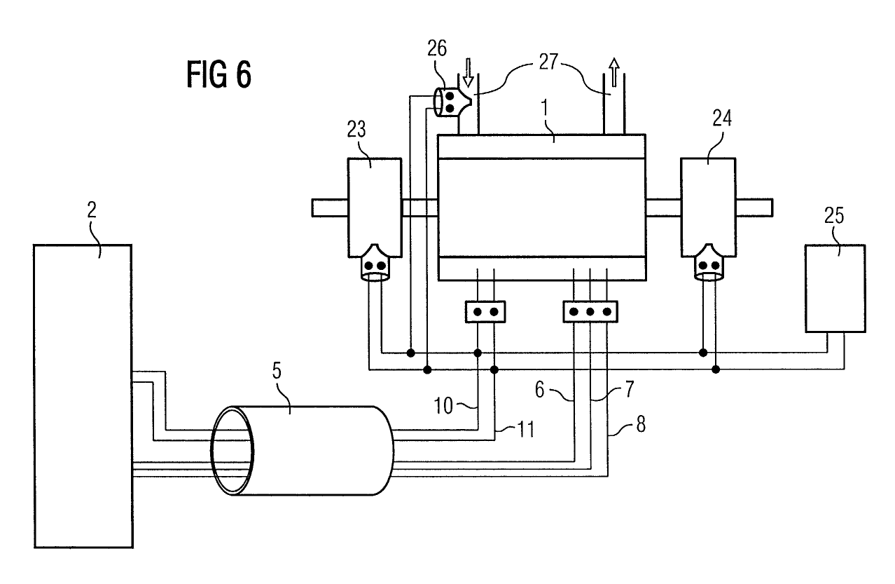

One such possible arrangement is shown in FIG. 6. While the closed-loop drive control side 2 corresponds to the block diagram in FIG. 1, a number of further sensors and actuators are provided in addition to the respective motor identification means at the end of the communication channel 5 adjacent to the motor 1, or the motors (in this case the active parts of a main spindle of a machine tool). In the illustrated example, these are two bearings with associated structure-borne sound sensors 23, 24 together with a temperature sensor 26 for monitoring the cooling water inlet 27 and an unbalance sensor 25 (for example for monitoring the tool stress). This makes it possible to save considerable cabling complexity for the individual sensors and actuators to a central evaluation device, and the computation capacity of the control system in a machine tool and production machine can be used for other purposes since this can then increasingly be established as a platform for general communication and automation.

I claim:

1. An electrical drive comprising a motor, closed-loop drive control and an integrated, autonomous motor identification means, wherein the motor identification means is arranged in the motor.

2. The electrical drive according to claim 1, wherein the motor identification means is a digital module in the form of a non-volatile memory.

3. The electrical drive according to claim 1, wherein the motor identification means is arranged in the active part of the motor.

4. The electrical drive according to claim 1, further comprising a bidirectional communication channel between the closed-loop drive control and the motor identification means.

5. The electrical drive according to claim 4, wherein the bidirectional communication channel is integrated in a motor cable.

6. The electrical drive according to claim 5, wherein a number of motors are connected parallel and cables for each communication channel is likewise connected in parallel to the closed-loop drive control.

7. The electrical drive according to claim 4, wherein the bidirectional communication channel is in the form of a two-wire cable.

8. The electrical drive according to claim 7, wherein a charge storage device is integrated in the motor identification means, said device being charged by means of a high level on the two-wire cable.

9. The electrical drive according to claim 1, wherein a temperature sensor is integrated in the motor identification means, and positioned substantially at a point to be measured.

10. The electrical drive according to claim 9, wherein the temperature sensor has an actual temperature value which can be checked periodically by the closed-loop drive control via the bidirectional communication channel.

11. The electrical drive according to claim 9, wherein the motor identification means has a preset temperature threshold and, if this temperature threshold is exceeded, an alarm signal can be passed to the closed-loop drive control via the bidirectional communication channel.

12. The electrical drive according to claim 4, wherein a communication channel has a driver on the closed-loop drive control which has an analog/digital converter for the evaluation of an external temperature sensor.

13. The electrical drive according to claim 12, wherein the closed-loop drive control has an analog input which has a pull-up resistor which is connected via the bidirectional communication channel to the motor identification means, and further wherein the pull-up resistor together with the motor identification means form a voltage divider.

14. The electrical drive according to claim 1, wherein the motor identification means has at least one digital input for checking commutation information.

15. The electrical drive according to claim 14, wherein the communication information is a rotor position checked by evaluation with Hall sensors arranged in the motor.

16. The electrical drive according to claim 1, wherein the motor identification means has a memory area which can be written to for holding an operating configuration and/or fault information.

17. A method of manufacturing an electrical drive comprising using a motor identification means for identification and/or as a data storage medium for test information or batch information associated with the motor.

18. A mechatronic system having an electrical drive according to claim 1, said system having a master-slave mode, wherein sensors and/or actuators associated with the mechatronic system can be connected as slaves to a bidirectional communication channel which originates from the closed-loop drive control as the master.

19. A method for motor identification of a plurality of motors which are connected in parallel to a closed-loop drive control in which motor phase cables and a bidirectional communication channel are connected in parallel, comprising, at the start of operation, having the closed-loop drive control communicate with individual motor identification means of the individual motors via a bidirectional communication bus, whereby each motor is identified on the basis of its motor identification means, and/or the connected configuration motor is identified, and/or a check is carried out to determine the permissibility of connecting the motors in parallel.

20. The method for motor identification with an electrical drive according to claim 13, wherein no motor identification means with an integrated temperature sensor can be identified, comprising making a direct measurement via the voltage divider formed from a pull-up resistor and an external temperature sensor.

21. A primary part of an electric motor having integrated therein an autonomous motor identification means according to claim 4.
